(19) United States
(12) Patent Application Publication
(10) Pub. No.: US 2016/0180194 A1
(43) Pub. Date: Jun. 23, 2016

(54) SYSTEMS AND METHODS FOR IDENTIFYING A REGION OF AN IMAGE

(71) Applicant: QUALCOMM Incorporated, San Diego, CA (US)

(72) Inventor: Ronald Karyodisa, San Diego, CA (US)

(21) Appl. No.: 14/580,631

(22) Filed: Dec. 23, 2014

(51) Int. Cl. G06K 9/62; G06K 9/46

(52) U.S. Cl. CPC G06K 9/6202; G06K 9/4642; G06K 9/4638

(57) ABSTRACT

A method for identifying a region of an image by an electronic device is described. The method includes initializing a hybrid data structure. The hybrid data structure is a combination of stack and queue structures. The method also includes traversing pixels of the image in accordance with the hybrid data structure in an order that prioritizes pixels in a first dimension over pixels in a second dimension. All contiguous pixels of the region in the first dimension are traversed before traversal in the second dimension.

### TECHNICAL FIELD

The present disclosure relates generally to electronic devices. More specifically, the present disclosure relates to systems and methods for identifying a region of an image.

### BACKGROUND

In the last several decades, the use of electronic devices has become common. In particular, advances in electronic technology have reduced the cost of increasingly complex and useful electronic devices. Cost reduction and consumer demand have proliferated the use of electronic devices such that they are practically ubiquitous in modern society. As the use of electronic devices has expanded, so has the demand for new and improved features of electronic devices. More specifically, electronic devices that perform new functions and/or that perform functions faster, more efficiently or more reliably are often sought after.

Some electronic devices utilize digital images. For example, a smartphone may capture and process a digital image. However, processing digital images may involve complex operations that require significant resources (e.g., time and power). As can be observed from this discussion, systems and methods that improve digital image processing may be beneficial.

### SUMMARY

A method for identifying a region of an image by an electronic device is described. The method includes initializing a hybrid data structure. The hybrid data structure is a combination of stack and queue structures. The method also includes traversing pixels of the image in accordance with the hybrid data structure in an order that prioritizes pixels in a first dimension over pixels in a second dimension. All contiguous pixels of the region in the first dimension are traversed before traversal in the second dimension. The hybrid data structure may have a start index, an end index, a reversed start index and a reversed end index.

Prioritizing pixels in a first dimension over pixels in a second dimension may include evaluating neighboring pixels in the first dimension before evaluating neighboring pixels in the second dimension in each iteration. Prioritizing pixels in a first dimension over pixels in a second dimension may provide a greater probability of cache hits.

The method may include evaluating neighboring pixels of an origin pixel at each iteration to identify any of the neighboring pixels belonging to the region. The method may include adding all of the neighboring pixels in the first dimension that belong to the region to the hybrid data structure before adding any of the neighboring pixels in the second dimension that belong to the region. The first dimension may correspond to a row dimension of the image and the second dimension may correspond to a column dimension of the image or the first dimension may correspond to a column dimension of the image and the second dimension may correspond to a row dimension of the image.

In an iteration, the method may include decrementing the start index and adding a first pixel in a first direction of the first dimension to the hybrid data structure at the start index in response to determining that the first pixel belongs to the region. In the iteration, the method may include decrementing the start index and adding a second pixel in a second direction of the first dimension to the hybrid data structure at the start index in response to determining that the second pixel belongs to the region. In the iteration, the method may include adding a third pixel in a second direction of the second dimension to the hybrid data structure at the end index and incrementing the end index in response to determining that the third pixel belongs to the region. In the iteration, the method may include adding a fourth pixel in a first direction of the second dimension to the hybrid data structure at the reversed end index and decrementing the reversed end index in response to determining that the fourth pixel belongs to the region.

One or more pixels may be added to a front of the hybrid data structure and one or more pixels may be added from a back of the hybrid data structure. Traversing pixels of the image may include traversing the one or more pixels from the back of the hybrid data structure only after no pixel remains for traversal from the front of the hybrid data structure.

An electronic device for identifying a region of an image is also described. The electronic device includes a processor and memory in electronic communication with the processor. The electronic device also includes instructions stored in the memory. The instructions are executable by the processor to initialize a hybrid data structure. The hybrid data structure is a combination of stack and queue structures. The instructions are also executable to traverse pixels of the image in accordance with the hybrid data structure in an order that prioritizes pixels in a first dimension over pixels in a second dimension. All contiguous pixels of the region in the first dimension are traversed before traversal in the second dimension.

A computer-program product for identifying a region of an image is also described. The computer-program product includes a non-transitory tangible computer-readable medium with instructions. The instructions include code for causing an electronic device to initialize a hybrid data structure. The hybrid data structure is a combination of stack and queue structures. The instructions also include code for causing the electronic device to traverse pixels of the image in accordance with the hybrid data structure in an order that prioritizes pixels in a first dimension over pixels in a second dimension. All contiguous pixels of the region in the first dimension are traversed before traversal in the second dimension.

### BRIEF DESCRIPTION OF THE DRAWINGS

FIG. 1 is a diagram illustrating one example of a pixel with four neighboring pixels;

FIG. 2 is a diagram illustrating an example image;

FIG. 3 is a block diagram illustrating one configuration of an electronic device in which systems and methods for identifying a region of an image may be implemented;

FIG. 4 is a flow diagram illustrating one configuration of a method for identifying a region of an image;

FIG. 5 is a diagram illustrating one example of the hybrid data structure;

FIG. 6 is a flow diagram illustrating a more specific configuration of a method for identifying a region of an image;

FIG. 7 is a block diagram illustrating one example of an electronic device in which systems and methods for identifying a region of an image may be implemented;

FIG. 8 is a block diagram illustrating one configuration of a wireless communication device in which systems and methods for identifying a region of an image may be implemented; and

FIG. 9 illustrates certain components that may be included within an electronic device.

### DETAILED DESCRIPTION

Systems and methods for identifying a region of an image are described herein. Identifying the region of the image may be accomplished with a hybrid data structure that is a combination of stack and queue structures. In some configurations, the hybrid data structure may be applied performing region grow with a neighborhood of four connected or adjacent pixels. The identified region of the image may be utilized in one or more image segmentation applications, for example.

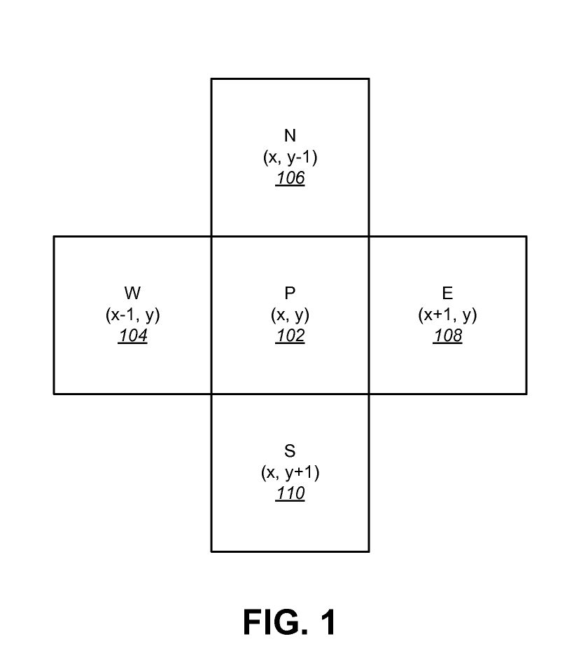

FIG. 1 is a diagram illustrating one example of a pixel 102 with four neighboring pixels 104, 106, 108, 110. The four neighboring pixels 104, 106, 108, 110 are connected to or adjacent to the pixel 102. Image segmentation region grow with a four-connected neighborhood is an image segmentation technique that evaluates four neighboring pixels 104, 106, 108, 110 of an initial pixel 102 and determines whether the pixel neighbors 104, 106, 108, 110 should be added to the region. Region grow may iterate until the region grows to the border of the image or a neighboring pixel is not part of the region (e.g., does not belong to the region).

For convenience herein, the pixel 102 may be referred to as P, a current pixel, origin pixel and/or a central pixel. One or more of the pixels 102, 104, 106, 108, 110 may be referred to in terms of dimensions. A first dimension of pixels (e.g., x) may be a set of pixels along a line. For example, a first dimension of pixels may be a row of pixels in an image. In another example, the first dimension of pixels may be a column of pixels in an image. A second dimension of pixels (e.g., y) may be another set of pixels along a line that is perpendicular to the first dimension. For example, a second dimension of pixels may be a column of pixels in an image. In another example, the second dimension of pixels may be a row of pixels in an image.

A neighboring pixel 104 in a first direction (e.g., negative direction, x−1) of a first dimension (e.g., x) may be referred to as W or west pixel (e.g., (x−1, y)). A neighboring pixel 108 in a second direction (e.g., positive direction, x+1) of the first dimension (e.g., x) may be referred to as E or east pixel (e.g., (x+1, y)). A neighboring pixel 106 in a first direction (e.g., negative direction, y−1) of a second dimension (e.g., y) may be referred to as N or north pixel (e.g., (x, y−1)). A neighboring pixel 110 in a second direction (e.g., positive direction, y+1) of the second dimension (e.g., y) may be referred to as S or south pixel (e.g., (x, y+1)).

One approach to iteratively identify all pixels in the region is by using a queue to collect all neighboring pixels of P 102 that belong to the region. After all neighbors of P 102 are evaluated, it takes the next pixel (which is a neighbor to P 102) from the queue and continues to evaluate the 4 neighbors of this next pixel. This continues until the queue is empty. It will be empty when the neighboring pixels are not part of the same region or it reaches the side of the image.

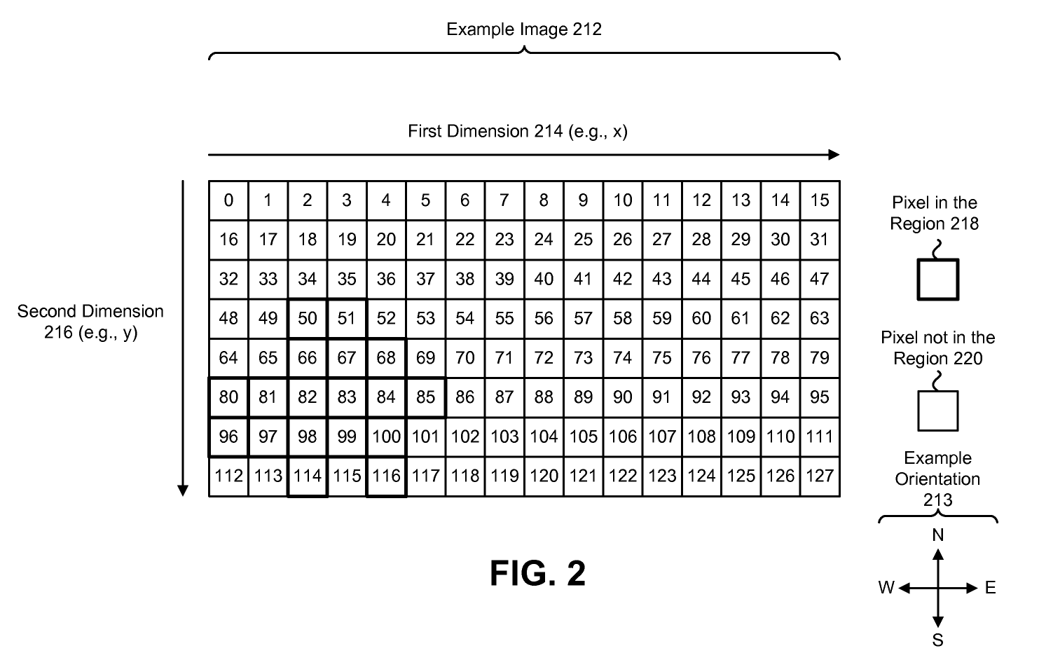

FIG. 2 is a diagram illustrating an example image 212. The example image 212 includes 128 pixels. The pixels span a first dimension 214 (e.g., x) and a second dimension 216 (e.g., y). For example, the first dimension 214 may represent the width of the image 212, while the second dimension 216 may represent the height of the image 212. An example orientation 213 is also provided in FIG. 2. Assuming pixel 82 as an origin pixel, for instance, pixel 83 would be an east pixel, pixel 81 would be a west pixel, pixel 66 would be a north pixel and pixel 98 would be a south pixel.

The example image 212 includes a region formed by a group of pixels, where each pixel in the region 218 is denoted with heavy lines. Pixels in the region 218 may be distinguished from pixels not in the region 220 based on one or more properties of the pixels. For example, the region may include pixels 218 having a particular intensity (e.g., grayscale), a range of intensities, a color or range of colors. Additionally or alternatively, the region may include pixels 218 that differ (as indicated by a gradient, for example) by less than a threshold amount from one or more neighboring pixels in intensity and/or color. In other configurations, the region may include pixels 218 that do not include a particular intensity and/or color and/or that differ by more than a threshold amount from one or more neighboring pixels in intensity and/or color. In some implementations, the region may correspond to an object with particular properties (e.g., intensity, color, shape, etc.). For example, the region may correspond to a face, an eye, a hand, a person, a box, a label, a vehicle, etc., in the image 212.

Assume that the example image 212 is obtained and that the initial pixel is at pixel 82. With the approach explained above and assuming a pixel order of west, north, east and south (e.g., a circular sequence), the queue will grow as illustrated in Table 1. In Table 1, “I” denotes iteration, “C” denotes row change, “P” denotes the origin pixel (e.g., the pixel being traversed), the asterisk (*) denotes the array index at the origin pixel for each iteration and the arrow (→) indicates the iteration at which a row change occurs.

TABLE 1

| | Array Index | | | | | | | | | | | | | | | | | | | |
|---|---|---|---|---|---|---|---|---|---|---|---|---|---|---|---|---|---|---|---|---|
| I | 0 | 1 | 2 | 3 | 4 | 5 | 6 | 7 | 8 | 9 | 10 | 11 | 12 | 13 | 14 | 15 | 16 | 17 | C | P |
| 0 | 82* | 81 | 66 | 83 | 98 | | | | | | | | | | | | | | | 82 |
| 1 | | 81* | 66 | 83 | 98 | 80 | 97 | | | | | | | | | | | | | 81 |
| 2 | | | 66* | 83 | 98 | 80 | 97 | 50 | 67 | | | | | | | | | | → | 66 |
| 3 | | | | 83* | 98 | 80 | 97 | 50 | 67 | 84 | 99 | | | | | | | | → | 83 |
| 4 | | | | | 98* | 80 | 97 | 50 | 67 | 84 | 99 | 114 | | | | | | | → | 98 |
| 5 | | | | | | 80* | 97 | 50 | 67 | 84 | 99 | 114 | | | | | | | → | 80 |
| 6 | | | | | | | 97* | 50 | 67 | 84 | 99 | 114 | 96 | | | | | | → | 97 |
| 7 | | | | | | | | 50* | 67 | 84 | 99 | 114 | 96 | 51 | | | | | → | 50 |
| 8 | | | | | | | | | 67* | 84 | 99 | 114 | 96 | 51 | 68 | | | | → | 67 |
| 9 | | | | | | | | | | 84* | 99 | 114 | 96 | 51 | 68 | 85 | | | → | 84 |
| 10 | | | | | | | | | | | 99* | 114 | 96 | 51 | 68 | 85 | 100 | | → | 99 |
| 11 | | | | | | | | | | | | 114* | 96 | 51 | 68 | 85 | 100 | | → | 114 |
| 12 | | | | | | | | | | | | | 96* | 51 | 68 | 85 | 100 | | → | 96 |
| 13 | | | | | | | | | | | | | | 51* | 68 | 85 | 100 | | → | 51 |
| 14 | | | | | | | | | | | | | | | 68* | 85 | 100 | | → | 68 |
| 15 | | | | | | | | | | | | | | | | 85* | 100 | | → | 85 |
| 16 | | | | | | | | | | | | | | | | | 100* | 116 | → | 100 |
| 17 | | | | | | | | | | | | | | | | | | 116* | → | 116 |

The queue as shown at Table 1 contains a somewhat random distribution of indexes. In this example, the origin pixel changes row 15 times, which may be compared to the region itself (in FIG. 2) that contains only 5 rows. The four connected neighbors are evaluated for each origin pixel. This means that memory access is required to evaluate the four connected neighbors. Assuming the width of the image is much bigger, iteratively accessing four neighboring pixels in the sequence of the above queue may result in many cache misses.

Typically, pixels in an image are addressed in memory in an order that proceeds along a row of an image and wraps to the next row of the image. This is illustrated by the pixel numbers of the example image 212 in FIG. 2. When a processor requests a pixel at a particular location, the requested pixel and a number of other pixels are loaded into a cache for fast access. Pixels may be loaded into the cache on a row-by-row basis. For example, a cache may be loaded with a certain number of bytes that represent the requested pixel and other pixels in an order that proceeds in address order (e.g., along a row and potentially wrapping to the next row). Depending on the memory request architecture and the placement of the requested pixel, the other pixels loaded into the cache may follow the requested pixel and/or precede the requested pixel in address order.

As can be observed, the order in which pixels are traversed and/or evaluated in the foregoing example may lead to many cache misses. Specifically, the foregoing example illustrates that traversing an image in that approach may require memory requests that often changes row. When a pixel that is not in the cache is requested, a cache miss occurs and slower memory is accessed in order to load the requested pixel (and a range of other pixels) into the cache. Because fast cache sizes are relatively small, requesting pixels from different rows can lead to cache misses and/or overwriting other relevant pixel data (e.g., rows) that will be accessed again as the image is traversed. Accordingly, the foregoing approach generally results in wasted time and energy.

The systems and methods disclosed herein provide an approach that traverses images faster and/or more efficiently than the foregoing approach. For example, the systems and methods disclosed herein may prioritize pixel traversal in a first dimension over a second dimension. Traversing pixels in this way may result in greater spatial and/or temporal locality of memory accesses. This may provide a higher probability of cache hits and/or a lower probability of cache misses, resulting in greater speed and efficiency of memory accesses when traversing the image to identify an image region. The following description provides examples of some configurations of the systems and methods disclosed herein. Various modifications may be made to the subject matter disclosed herein, without departing from the scope of the claims.

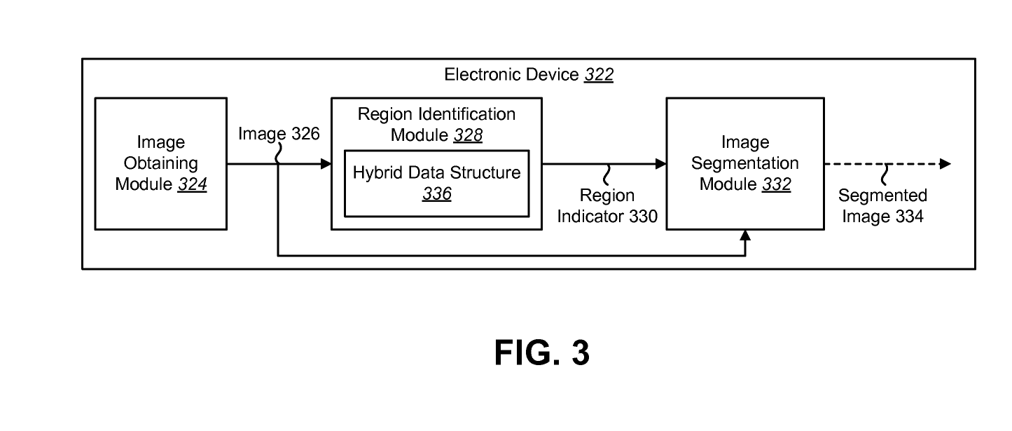

FIG. 3 is a block diagram illustrating one configuration of an electronic device 322 in which systems and methods for identifying a region of an image 326 may be implemented. Examples of the electronic device 322 include smartphones, cellular phones, digital cameras, tablet devices, laptop computers, desktop computers, video cameras, personal cameras, automotive system consoles, home appliances, gaming consoles, set-top boxes, head mounted displays, watches, healthcare devices, robots, inspection equipment, etc.

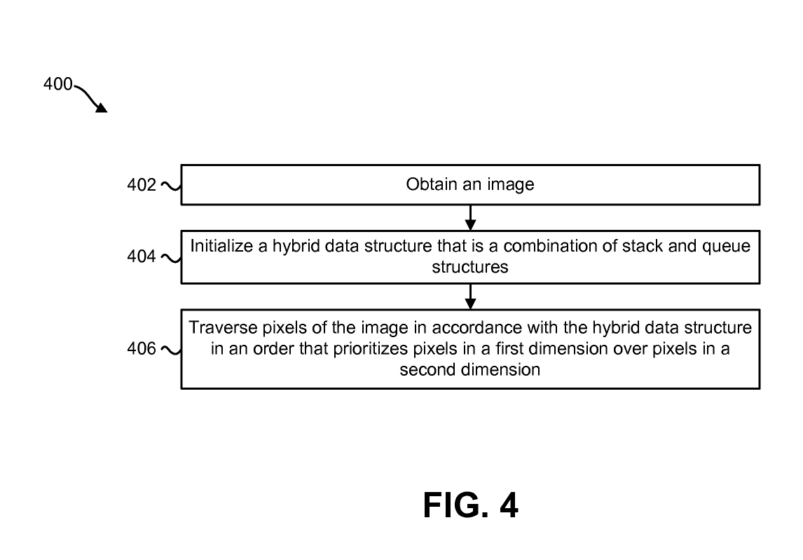

The electronic device 322 may include an image obtaining module 324, a region identification module 328 and/or an image segmentation module 332. As used herein, a “module” may be implemented in hardware (e.g., circuitry) or a combination of hardware and software. It should be noted that one or more of the modules described in connection with FIG. 3 may be optional. Furthermore, one or more of the modules may be combined or divided in some configurations. More specific examples of one or more of the functions, procedures and/or structures described in connection with FIG. 3 may be given in connection with one or more of FIGS. 4-9.

The image obtaining module 324 may obtain an image 326. For example, the electronic device 322 may capture an image 326 (e.g., digital image) using one or more image sensors and/or cameras. Additionally or alternatively, the electronic device 322 may receive the image 326 (e.g., digital image) from another device (e.g., a memory card, an external storage device, a web camera, a digital camera, a smartphone, a computer, a video camera, a remote network server, etc.).

The image 326 may be provided to the region identification module 328 and/or to the image segmentation module 332. The image 326 may be an entire original image or a portion of the original image. For example, the image 326 may be a subset of the pixels of the original image (e.g., a cropped portion of an original image, a down-sampled or decimated version of all or part of the original image, etc.). Additionally or alternatively, the image 326 may be a modified version of an original image. For example, the image 326 may be a gradient image (obtained by applying Sobel or Sharr operators to the original image, for example), a gray image (including only the intensity component of the original image, for example), a single band image (including only an intensity component, red component, green component or blue component, etc., of the original image) and/or a black-and-white image, etc. The image 326 may be a two-dimensional image.

The region identification module 328 may identify a region of the image 326. The region identification module 328 may initialize a hybrid data structure 336. The hybrid data structure 336 is a combination of stack and queue structures. A stack is a data structure that is accessed at one end (e.g., the “top” of the stack) in a last-in-first-out (LIFO) order. For example, data is written to one end of the stack (e.g., “pushed” onto the top of the stack) and is read from the same end of the stack (e.g., “popped” from to the top of the stack). A queue is a data structure that is accessed in a first-in-first-out (FIFO) order. For example, data is written to a front end of the queue (e.g., “queued”) and read from the back end of the queue. In some configurations, the hybrid data structure 336 may have four indices. For example, the hybrid data structure may have a start index, an end index, a reversed start index and a reversed end index.

The region identification module 328 may obtain an initial pixel (e.g., a starting pixel). In some configurations, the initial pixel may be based on a received input. For example, the electronic device 322 may detect a tap event from a touchscreen that indicates a starting pixel. In another example, the electronic device 322 may detect a click event (from a mouse, for example) that indicates the starting pixel. Additionally or alternatively, the electronic device 322 may determine an initial pixel based on an object detection algorithm. For example, the electronic device 322 may perform a scale-invariant feature transform (SIFT) to determine the initial pixel. The initial pixel may be a pixel in the image 326 where pixel traversal begins. In other words, the initial pixel may be the first traversed pixel.

The region identification module 328 may traverse pixels of the image 326 in accordance with the hybrid data structure in an order that prioritizes pixels in a first dimension over pixels in a second dimension. In this order, all contiguous pixels of the region in the first dimension are traversed before traversal in the second dimension. For example, contiguous pixels of the region are located next to each other (without an intervening pixel that is not in the region, for instance). A pixel is “traversed” when it is an origin pixel. While a neighboring pixel may be accessed for evaluation, this pixel is not “traversed” until it is the origin pixel.

It should be noted that the first dimension may correspond to a row dimension of the image 326 and the second dimension may correspond to a column dimension of the image 326 in some configurations. Alternatively, the first dimension may correspond to a column dimension of the image 326 and the second dimension may correspond to a row dimension of the image 326.

In some configurations, prioritizing pixels in the first dimension over pixels in the second dimension may include evaluating neighbor pixels in the first dimension before evaluating neighboring pixels in the second dimension in each iteration. For example, the region identification module 328 may evaluate the west pixel 104 and east pixel 108 before evaluating the south pixel 110 and north pixel 106. For instance, evaluation may proceed in one of the following orders: west, east, south, north; west, east, north, south; east, west, south, north, or east, west, north, south. In another example, the region identification module 328 may evaluate the south pixel 110 and north pixel 106 before evaluating the west pixel 104 and east pixel 108.

Prioritizing pixels in the first dimension over pixels in the second dimension may provide a greater probability of cache hits. For example, assume a configuration in which pixels are loaded into a cache proceeding along rows. Also assume that the first dimension is the row dimension. Traversing all contiguous pixels in the region in the row before traversing in the column direction (e.g., changing rows) provides a greater probability that the pixels accessed have already been loaded into the cache from an earlier access, thereby providing a greater probability of a cache hit (and a reduced probability of a cache miss). In the example given in connection with Table 1 above, it can be observed that without prioritizing row traversal over column traversal, rows may change often, resulting in a greater likelihood that the pixels accessed have not already been loaded into the cache (or have been overwritten in the cache), resulting in a greater probability of a cache miss.

The region identification module 328 may evaluate the neighboring pixels of the origin pixel at each iteration to identify any of the neighboring pixels belonging to the region. Neighboring pixels in the region may be distinguished from pixels not in the region based on one or more properties of the pixels. For example, the region identification module 328 may identify pixels having a particular intensity (e.g., grayscale), a range of intensities, a color or range of colors. Additionally or alternatively, the region identification module 328 may identify pixels that differ (as indicated by a gradient, for example) by less than a threshold amount from one or more neighboring pixels in intensity and/or color. In other configurations, the region identification module 328 may identify pixels that do not include a particular intensity and/or color and/or that differ by more than a threshold amount from one or more neighboring pixel in intensity and/or color. As described above, the region may correspond to an object with particular properties (e.g., intensity, color, shape, etc.). For example, the region may correspond to a face, an eye, a hand, a person, a box, a label, a vehicle, etc., in the image 326.

The region identification module 328 may, at each iteration, add all of the neighboring pixels in the first dimension that belong to the region to the hybrid data structure 336 before adding any of the neighboring pixels in the second dimension that belong to the region. For example, if any of the neighboring pixels in the first dimension are evaluated as belonging to the region, those one or more pixels (if any) may be added to the hybrid data structure 336 before any of the neighboring pixels in the second dimension that belong to the region (if any) are added.

The region identification module 328 may produce a region indicator 330. The region indicator 330 may indicate a set of pixels and/or an area of the image 326 that represents the region. The region indicator 330 may be provided to the image segmentation module.

The image segmentation module 332 may segment the image 326 (and/or an original image corresponding to the image 326, for example). Segmenting the image 326 may include performing an operation on the image 326 (or an original image corresponding to the image 326, for example) based on the region indicated by the region indicator 330. For example, the image segmentation module 332 may track the region, perform object recognition based on the region, focus a camera to the region, remove the region, replace the region, copy the region and/or crop to the region (or to a bounding box of the region, for example), etc. For example, the image segmentation module 332 may optionally provide a segmented image 334 that has removed and/or replaced the region. Additionally or alternatively, the identified region may be utilized to perform one or more operations, such as eye tracking (e.g., for 3-dimensional (3D) image processing), user interface (UI) control, camera steering, zoom, autofocus, etc.

FIG. 4 is a flow diagram illustrating one configuration of a method 400 for identifying a region of an image 326. The method 400 may be performed by the electronic device 322 described in connection with FIG. 3. The electronic device 322 may obtain 402 an image 326. This may be accomplished as described above in connection with FIG. 3, for example.

The electronic device 322 may initialize 404 a hybrid data structure 336 that is a combination of stack and queue structures. For example, the electronic device 322 (e.g., region identification module 328) may create (e.g., instantiate) the hybrid data structure 336. Initializing 404 the hybrid data structure 336 may include specifying a size (e.g., N elements and/or number of bytes). For example, the electronic device 322 may create a data structure that has N elements. In some configurations, the number of elements (e.g., N) in the hybrid data structure 336 may be set as the number of pixels in the image 326. In some configurations, initializing 404 the hybrid data structure 336 may include allocating memory for the hybrid data structure 336. In one example, the electronic device 322 may reserve a portion of memory (e.g., a range of addresses, pointers, etc.) to accommodate the elements of the hybrid data structure 336. In another example, the electronic device 322 may allocate memory (e.g., an address, range of addresses, pointer, range of pointers, etc.) as elements (e.g., pixels) are added to the hybrid data structure 336.

In some configurations, the hybrid data structure 336 may be implemented as an array. The array may have an address (e.g., index or key) corresponding to each element in the array. In other configurations, the hybrid data structure 336 may be implemented based on one or more other structures, such as hash tables, trees, lists, etc.

In some configurations, the hybrid data structure 336 may have four indices. For example, the hybrid data structure 336 may have a start index, an end index, a reversed start index and a reversed end index. Initializing 404 the hybrid data structure may include initializing each of the indices of the hybrid data structure. In some configurations, the hybrid data structure index (e.g., array index) ranges from 0 to N−1 (where N is the number of elements in the hybrid data structure). In these configurations, the start index may be initialized to 1, the end index may be initialized to 1, the reversed start index may be initialized to N−1 and the reversed end index may be initialized to N−1.

The electronic device 322 may traverse 406 pixels of the image 326 in accordance with the hybrid data structure 336 in an order that prioritizes pixels in a first dimension over pixels in a second dimension. This may be accomplished as described above in connection with FIG. 1. For example, the electronic device 322 may obtain an initial pixel of the image 326 and traverse the pixels of the image 326 until the region is determined (e.g., all edges of the region have been reached). To reduce cache misses, the traversing 406 should access the closer neighboring pixels first and the farther neighboring pixels last. Using a hybrid data structure 325 as described herein may reduce cache misses.

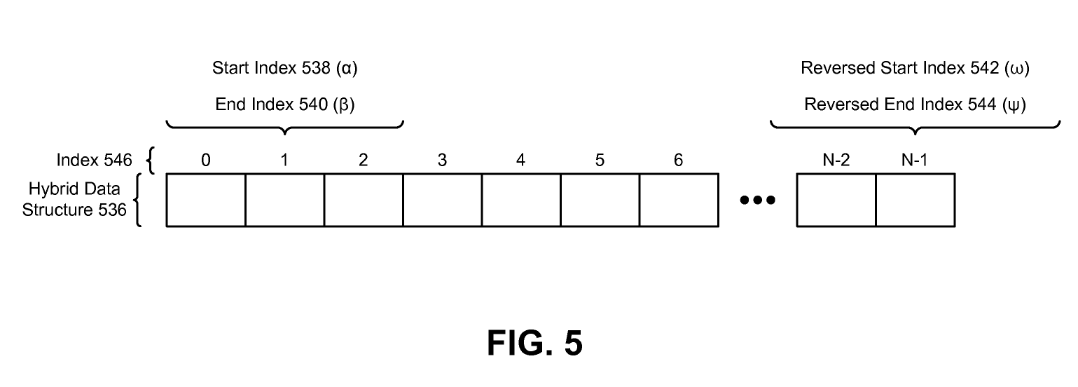

FIG. 5 is a diagram illustrating one example of the hybrid data structure 536. In this example, the hybrid data structure 536 has N elements that are indexed 546 from 0 to N−1. The hybrid data structure 536 is a combination of a stack structure and a queue structure. The hybrid data structure 536 has four indices in this example: a start index 538 (denoted α for convenience), an end index 540 (denoted β for convenience), a reversed start index (denoted ω for convenience) and a reversed end index 544 (denoted ψ for convenience). As described above, initializing the hybrid data structure 536 may include initializing the indices of the hybrid data structure. For instance, the electronic device 322 may set the initial start index 538 to 1, the initial end index 540 to 1, the initial reversed start index 542 to N−1 and the initial reversed end index 544 to N−1.

An example of traversing the pixels in accordance with the hybrid data structure 536 is given as follows. The storing order has more priority to the east and west pixels. For example, the electronic device 322 may push the west pixels first then the east pixels using a stack (e.g., LIFO) mechanism based on the start index 538. The next priority will be queuing the south pixel to the end index 540 and the north pixel to the reversed end index 544.

The priority order for getting the pixels will first be given to the stack/queue that is based on the start index 538 (e.g., that uses the start index 538 by comparing the start index 538 and the end index 540), which may be referred to as the front stack/queue. Then, the priority order proceeds to the reversed queue that is based on the reversed start index 542 (e.g., that uses the reversed start index 542 by comparing the reversed start index 542 and the reversed end index 544), which may be referred to as the reversed queue. Only after the front stack/queue has no pixels, traversal can begin on the reversed queue.

Table 2 illustrates the progression of the traversal in accordance with the hybrid data structure 536 as applied to the region illustrated in FIG. 2. In Table 2, “I” denotes iteration, “C” denotes row change, “P” denotes the origin pixel (e.g., the pixel being traversed), the alpha (a) denotes the start index 538, the beta (β) denoted the end index 540, the omega (ω) denotes the reversed start index 542, the psi (ψ) denotes the reversed end index 544 and the arrow (→) indicates the iteration at which a row change occurs.

TABLE 2

| | Array Index | | | | | | | | | | | | | | | | |
|---|---|---|---|---|---|---|---|---|---|---|---|---|---|---|---|---|---|
| I | 0 | 1 | 2 | 3 | 4 | 5 | 6 | 7 | 8 | . . . | N-5 | N-4 | N-3 | N-2 | N-1 | C | P |
| 0 | | 82^{αβ} | | | | | | | | | | | | | | | 82 |
| 1 | 83^{α} | 81 | 98^{β} | | | | | | | | | | | | 66^{ωψ} | | 83 |
| 2 | 84^{α} | 81 | 98 | 99^{β} | | | | | | | | | | 67^{ψ} | 66^{ω} | | 84 |
| 3 | 85^{α} | 81 | 98 | 99 | 100^{β} | | | | | | | | 68^{ψ} | 67 | 66^{ω} | | 85 |
| 4 | | 81^{α} | 98 | 99 | 100^{β} | | | | | | | | 68^{ψ} | 67 | 66^{ω} | | 81 |
| 5 | | 80^{α} | 98 | 99 | 100 | 97^{β} | | | | | | | 68^{ψ} | 67 | 66^{ω} | | 80 |
| 6 | | | 98^{α} | 99 | 100 | 97 | 96^{β} | | | | | | 68^{ψ} | 67 | 66^{ω} | → | 98 |
| 7 | | | | 99^{α} | 100 | 97 | 96 | 114^{β} | | | | | 68^{ψ} | 67 | 66^{ω} | | 99 |
| 8 | | | | | 100^{α} | 97 | 96 | 114^{β} | | | | | 68^{ψ} | 67 | 66^{ω} | | 100 |
| 9 | | | | | | 97^{α} | 96 | 114 | 116^{β} | | | | 68^{ψ} | 67 | 66^{ω} | | 97 |
| 10 | | | | | | | 96^{α} | 114 | 116^{β} | | | | 68^{ψ} | 67 | 66^{ω} | | 96 |
| 11 | | | | | | | | 114^{α} | 116^{β} | | | | 68^{ψ} | 67 | 66^{ω} | → | 114 |
| 12 | | | | | | | | | 116^{αβ} | | | | 68^{ψ} | 67 | 66^{ω} | | 116 |
| 13 | | | | | | | | | | | | | 68^{ψ} | 67 | 66^{ω} | → | 66 |
| 14 | | | | | | | | | | | | 50^{ψ} | 68 | 67^{ω} | | | 67 |
| 15 | | | | | | | | | | | 51^{ψ} | 50 | 68^{ω} | | | | 68 |
| 16 | | | | | | | | | | | 51^{ψ} | 50^{ω} | | | | → | 50 |
| 17 | | | | | | | | | | | 51^{ωψ} | | | | | | 51 |

The result illustrated in Table 2 in the P column shows denser pixel groupings. In particular, with hybrid data structure 536, the traversed pixels being accessed are much closer. There are five groups of traversed pixels that located at the same row (e.g., [82, 83, 84, 85, 81, 80], [98, 99, 100, 97, 96], [114, 116], [66, 67, 68] and [50, 51]). In this example, the traversed pixels changes row only four times, which are similar to the number of rows of the region itself (as illustrated in FIG. 2) that contains only five rows. This approach helps to reduce the cache misses, which results in much faster performance.

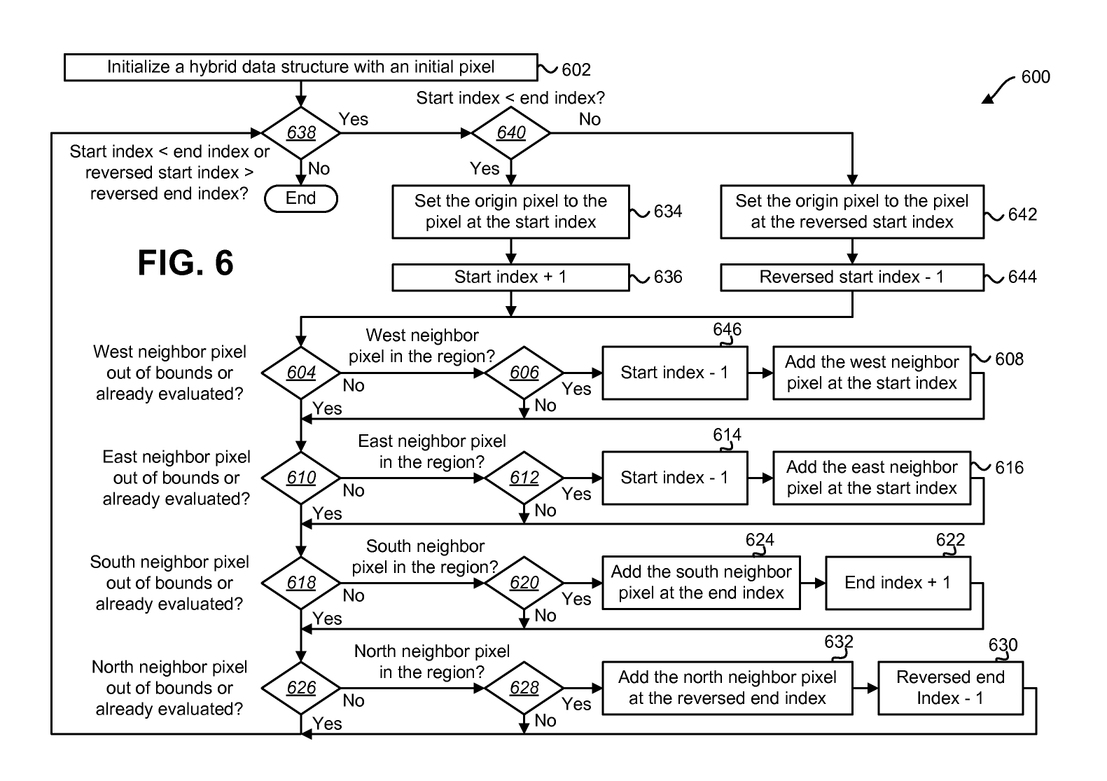

FIG. 6 is a flow diagram illustrating a more specific configuration of a method 600 for identifying a region of an image 326. The method 600 may be performed by the electronic device 322 described in connection with FIG. 3.

The electronic device 322 may initialize 602 a hybrid data structure 336 that is a combination of stack and queue structures. This may be accomplished as described above in connection with one or more of FIGS. 3-5. For example, the electronic device 322 may initialize 602 the hybrid data structure with an initial pixel (e.g., an initial origin pixel). For example, the electronic device 322 may create the hybrid data structure, initialize the start index, the end index, the reversed start index and the reversed end index and may add the initial pixel (e.g., origin pixel) to the hybrid data structure at the end index. The electronic device 322 may increment the end index (e.g., add 1 to the end index).

The electronic device 322 may determine 638 if the start index is less than the end index or if the reversed start index is greater than the reversed end index. If the start index is not less than the end index and the reversed start index is not greater than the reversed end index, operation may end. If the start index is less than the end index or if the reversed start index is greater than the reversed end index, the electronic device 322 may determine 640 whether the start index is less than the end index.

If the start index is less than the end index, the electronic device 322 may set 634 the origin pixel (e.g., center pixel) to the pixel at the start index. The electronic device 322 may increment 636 the start index (e.g., add 1 to the start index). The electronic device 322 may proceed to determine 604 whether the west neighbor pixel is out of bounds or has already been evaluated.

If the start index is not less than the end index, the electronic device 322 may set 642 the origin pixel (e.g., center pixel) to the pixel at the reversed start index. The electronic device 322 may decrement 644 the reversed start index (e.g., subtract 1 from the reversed start index). The electronic device 322 may proceed to determine 604 whether the west neighbor pixel is out of bounds or has already been evaluated.

The electronic device 322 may determine 604 whether the west neighbor pixel is out of bounds or has already been evaluated. For example, as the pixels are evaluated and traversed, the electronic device 322 may label the pixels (as evaluated, for example) and/or maintain a record of pixel numbers, coordinate numbers and/or addresses that have been evaluated. If the west neighbor pixel is out of bounds (e.g., there is no west neighbor pixel because it is beyond the edge of the image or a corresponding coordinate number is in an invalid range) or if the label and/or record indicates that the west neighbor pixel has already been evaluated, the electronic device 322 may determine 610 whether the east neighbor pixel is out of bounds or has already been evaluated.

If the west neighbor pixel is not out of bounds (e.g., there is a west pixel and its coordinate is in a valid range) and has not been evaluated already (e.g., the west neighbor pixel is not labeled and/or recorded as having been evaluated), the electronic device 322 may evaluate 606 whether the west neighbor pixel belongs to the region. This evaluation 606 may be made based on one or more properties of the (west neighbor) pixel as described above. For example, the west neighbor pixel may belong to the region (e.g., may be in the region) if the west neighbor pixel has a particular intensity (e.g., grayscale), a range of intensities, a color or range of colors. In other words, a pixel may be determined as belonging to the region if the pixel satisfies one or more intensity thresholds (e.g., greater than an intensity threshold and/or less than an intensity threshold) and/or one or more color thresholds. Additionally or alternatively, the west neighbor pixel may belong to the region if the west neighbor pixel differs (as indicated by a gradient, for example) by less than a threshold amount from one or more neighboring pixels in intensity and/or color. In other configurations, the west neighbor pixel may belong to the region if the west neighbor pixel does not include a particular intensity and/or color and/or differs by more than a threshold amount from one or more adjacent pixels in intensity and/or color. The west neighbor pixel may be labeled and/or recorded as having been evaluated 606. If the west neighbor pixel does not belong in the region, the electronic device 322 may determine 610 whether the east neighbor pixel is out of bounds or has already been evaluated.

If the west neighbor pixel belongs to the region (e.g., in response to determining that the west neighbor pixel belongs to the region), the electronic device 322 may decrement 646 the start index (e.g., subtract 1 from the start index). The electronic device 322 may add 608 the west neighbor pixel (e.g., pixel data, address data, a pixel indicator, etc.) to the hybrid data structure 336 at the start index. The electronic device 322 may proceed to determine 610 whether the east neighbor pixel is out of bounds or has already been evaluated.

The electronic device 322 may determine 610 whether the east neighbor pixel is out of bounds or has already been evaluated. This may be accomplished similarly as described in connection with the west neighbor pixel, but for the east neighbor pixel instead. If the east neighbor pixel is out of bounds (e.g., there is no east neighbor pixel because it is beyond the edge of the image or a corresponding coordinate number is in an invalid range) or if the east neighbor pixel has already been evaluated, the electronic device 322 may determine 618 whether the south neighbor pixel is out of bounds or has already been evaluated.

If the east neighbor pixel is not out of bounds and has not been evaluated already, the electronic device 322 may evaluate 612 whether the east neighbor pixel belongs to the region. This evaluation 612 may be made based on one or more properties of the pixel as described above (in connection with the west neighbor pixel but for the east neighbor pixel instead). The east neighbor pixel may be labeled and/or recorded as having been evaluated 612. If the east neighbor pixel does not belong in the region, the electronic device 322 may determine 618 whether the south neighbor pixel is out of bounds or has already been evaluated.

If the east neighbor pixel belongs to the region (e.g., in response to determining that the east neighbor pixel belongs to the region), the electronic device 322 may decrement 614 the start index (e.g., subtract 1 from the start index). The electronic device 322 may add 616 the east neighbor pixel to the hybrid data structure 336 at the start index. The electronic device 322 may proceed to determine 618 whether the south neighbor pixel is out of bounds or has already been evaluated.

The electronic device 322 may determine 618 whether the south neighbor pixel is out of bounds or has already been evaluated. This may be accomplished similarly as described in connection with the west neighbor pixel, but for the south neighbor pixel instead. If the south neighbor pixel is out of bounds (e.g., there is no south neighbor pixel because it is beyond the edge of the image or a corresponding coordinate number is in an invalid range) or if the south neighbor pixel has already been evaluated, the electronic device 322 may determine 626 whether the north neighbor pixel is out of bounds or has already been evaluated.

If the south neighbor pixel is not out of bounds and has not been evaluated already, the electronic device 322 may evaluate 620 whether the south neighbor pixel belongs to the region. This evaluation 620 may be made based on one or more properties of the pixel as described above (in connection with the west neighbor pixel but for the south neighbor pixel instead). The south neighbor pixel may be labeled and/or recorded as having been evaluated 620. If the south neighbor pixel does not belong in the region, the electronic device 322 may determine 626 whether the north neighbor pixel is out of bounds or has already been evaluated.

If the south neighbor pixel belongs to the region (e.g., in response to determining that the south neighbor pixel belongs to the region), the electronic device 322 may add 624 the south neighbor pixel to the hybrid data structure 336 at the end index. The electronic device 322 may increment 622 the end index (e.g., add 1 to the end index). The electronic device 322 may proceed to determine 626 whether the north neighbor pixel is out of bounds or has already been evaluated.

The electronic device 322 may determine 626 whether the north neighbor pixel is out of bounds or has already been evaluated. This may be accomplished similarly as described in connection with the west neighbor pixel, but for the north neighbor pixel instead. If the north neighbor pixel is out of bounds (e.g., there is no north neighbor pixel because it is beyond the edge of the image or a corresponding coordinate number is in an invalid range) or if the north neighbor pixel has already been evaluated, the electronic device 322 may return to determine 638 if the start index is less than the end index or if the reversed start index is greater than the reversed end index.

If the north neighbor pixel is not out of bounds and has not been evaluated already, the electronic device 322 may evaluate 628 whether the north neighbor pixel belongs to the region. This evaluation 628 may be made based on one or more properties of the pixel as described above (in connection with the west neighbor pixel but for the north neighbor pixel instead). The north neighbor pixel may be labeled and/or recorded as having been evaluated 628. If the north neighbor pixel does not belong in the region, the electronic device 322 may return to determine 638 if the start index is less than the end index or if the reversed start index is greater than the reversed end index.

If the north neighbor pixel belongs to the region (e.g., in response to determining that the north neighbor pixel belongs to the region), the electronic device 322 may add 632 the north neighbor pixel to the hybrid data structure 336 at the reversed end index. The electronic device 322 may decrement 630 the reversed end index (e.g., subtract 1 from the reversed end index). The electronic device 322 may return to determine 638 if the start index is less than the end index or if the reversed start index is greater than the reversed end index.

It should be noted that in some configurations, the electronic device 322 may apply “lazy” evaluation to one or more of the “OR” and “AND” conditions described. For example, the electronic device 322 may first determine whether a neighbor pixel is out of bounds to avoid determining whether that pixel has already been evaluated in the case that the neighbor pixel is out of bounds. In that way, a specific determination of whether a pixel has already been evaluated may be avoided in some cases.

A pseudo code example of one implementation of the systems and methods disclosed herein is given in Listing (1):

Listing 1

```
Input: pointer to an image and/or image property (e.g., grayscale, gradient, range of
intensity, range of colors, etc.). The source image and/or property may be denoted “src.”
Sample of Output: pointer to segLabel (segmentation label)
    segLabel covers all pixel in the src image.
    For simplicity: If src has width and height, segLabel size is equal to srcWidth *
srcHeight
    In this example, the same number, starting from 1, indicates the pixel belong to the
same image segmentation region.
// Apply a hybrid data structure (as described in connection with Figure 5, for example),
which is a combination of stack and queue that has four indexes
int startIndex, endIndex, reversedStartIndex, reversedEndIndex;
int growXHybridDS[N];  // N can be equal to srcWidth * srcHeight
int growYHybridDS[N];
int lastIndex = N − 1;
// Look at Figure 1 for Pixel location.
// Neighborhoods: West, East, South, North
// Apply LIFO (Last In First Out, stack algorithm) for West and East.
// It means East will have number 1 priority to be examined because it is First being Out.
// After that, apply FIFO (First In First Out, queue algorithm) for South to the endIndex and
North to the reversedEndIndex.
//   W, E, S, N
int neighborX[4] = { −1, 1, 0, 0 }
int neighborY[4] = { 0, 0, 1, −1 }
label = 0;  // Initialize label to 0
//set all segLabel to 0 to indicate the pixel not belong to any segmentation
memset(segLabel, 0, . . .);
. . .
while (any pixel need to be examined, e.g. from seed [seedX, seedY] )
{
  int *currentSegLabel = segLabel + seedY * srcWidth + seedX;
  if (*currentSegLabel == 0)  // not belong to any segmentation
  {
    label++;  // mark as a new label
    *currentSegLabel = label;
    // start to grow the image segmentation
    // Apply four indices (e.g., start index 538, end index 540, reversed start index 542
and reversed end index 544 as described in connection with Figure 5)
    // Start startIndex (e.g., start index 538) and endIndex (e.g., end index 540) with 1
    // Start reversedStartIndex (e.g., reversed start index 542) and reversedEndIndex
    // (e.g., reversed end index 544) with N-1
    startIndex = endIndex = 1;
    reversedStartIndex = reversedEndIndex = lastIndex;
    growXHybridDS [endIndex] = seedX;
    growYHybridDS [endIndex] = seedY;
    endIndex++;
    //While there is an element in the hybrid data structure (e.g., determine 638 whether
    // the start index is less than the end index or the reversed start index is greater than
    // the reversed end index):
    while (startIndex <endIndex || reversedStartIndex >reversedEndIndex)
    {
      // Step 1: Get the origin (e.g., center) pixel coordinate (X,Y) from hybrid data
    structure
      // Get data from startIndex or reversedStartIndex (e.g., determine 640 whether
      // the start index is less than the end index)
      if (startIndex <endIndex)
      {
        // more priority for the normal queue
        centerPixelX = growXHybridDS [startIndex];
        centerPixelY = growYHybridDS [startIndex];
        startIndex++;
      }
      else // (reversedStartIndex > reversedEndIndex)
      {
        // less priority for the reverse queue
        centerPixelX = growXHybridDS [reversedStartIndex];
        centerPixelY = growYHybridDS [reversedStartIndex];
        reversedStartIndex--;
      }
      // Step 2: Examine the 4 neighboring pixel of center pixel
      for (k = 0; k < 4; k++)
      {
        neighborX = centerPixelX + neighborX [k];
        neighborY = centerPixelY + neighborY [k];
        // Check whether a neighbor pixel is out of bounds (e.g., determine 604, 610,
        // 618, 626 whether a neighbor pixel is out of bounds)
        if (neighborX and neighborY inside of the image)
        {
        currentSegLabel = segLabel + neighborY * srcWidth + neighborX;
        // Check whether a neighbor pixel has already been evaluated (e.g.,
        // determine 604, 610, 618, 626 whether a neighbor pixel has already
        // been evaluated
        if (*currentSegLabel == 0)
        {
          . . .
          Do any region determination algorithm to decide whether the
          neighbor belong to the same region as the center pixel (e.g., evaluate
          the neighbor pixel to determine whether it belongs to the region)
          // Check whether a neighbor pixel is in the region (e.g., determine
          // 606, 612, 620, 628 whether a pixel belongs in the region)
          if (the neighbor belongs to the same region)
          {
              // The storing order has more priority to the East and West pixels.
              // (e.g., decrementing 646 the start index and adding 608 the west
              // neighbor pixel if it belongs to the region and/or decrementing
              // 614 the start index and adding 616 the east neighbor pixel if it
              // belongs to the region is prioritized over south and north pixels)
              // It pushes the West pixels first then the East pixels using stack
              // mechanism based on the startIndex.
              // k is the index for neighborX and neighborY array, which
              // indicates East, West, South, and North
              if (k<2)
              {
                // Most priority for horizontal neighbor
                // k = 0 and k = 1 is for West and East in order
                // more priority for EAST then WEST
                // Do stack push to the startIndex
                startIndex--;
                growYHybridDS [startIndex] = neighborY;
                growXHybridDS [startIndex] = neighborX;
                }
          // The next priority will be queuing South to the endIndex and
          // North to the reversedEndIndex (e.g., adding 624 the south
          // neighbor pixel at the end index and incrementing 622 the end
          // index if the south neighbor pixel is in the region and/or adding
          // 632 the north neighbor pixel and decrementing 630 the
          // reversed end index if the north neighbor pixel is in the region)
          // may have the next (e.g., lower) priority
          else if (k==2)
          {
                // queue for South neighbor
                growXHybridDS [endIndex] = neighborX;
                growYHybridDS [endIndex] = neighborY;
                endIndex++;
                }
                else // k==3
                {
                    // reverse queue for North neighbor
                    growXHybridDS +reversedEndIndex+ =neighborX;
                    growYHybridDS +reversedEndIndex+ =neighborY;
                    reversedEndIndex--;
                }
                //Mark this neighbor with the same label as center to indicate
                both center and the
                //current neighbor belong to the same image segmentation
                *currentSegLabel =labels;
                //Or depending on the purpose of the API, it can do something
                different
              }// end of if the neighbor belong to the same image segmentation
            }
          }
        }
      }
    }
  }
```

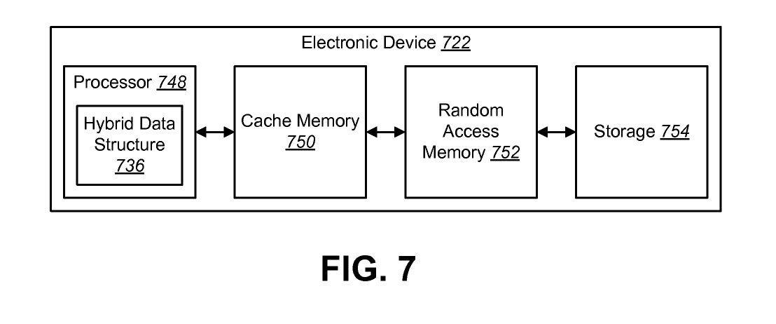

FIG. 7 is a block diagram illustrating one example of an electronic device 722 in which systems and methods for identifying a region of an image may be implemented. The electronic device 722 may include a processor, cache memory, random access memory 752 (RAM) and storage 754. Examples of storage 754 may include disk drives, solid state drives (SSDs), etc. The processor 748 may traverse an image in accordance with the hybrid data structure 736 described above. For example, the processor 748 may perform one or more of the functions described in connection with one or more of FIGS. 3-6.

In order to illustrate the benefits of the systems and methods disclosed herein, locality of reference is discussed, followed by some test results. Locality of reference (or principle of locality) is one theory in computer science that affects electronic device 722 performance. Temporal locality and spatial locality are two types of locality of reference.

Reuse of data and/or resources based on close time proximity is referred to as temporal locality. Using data based on storage location proximity is referred to as spatial locality. Processor 748 or hardware design may benefit from locality of reference. For example, the electronic device 722 may use a hierarchical memory to optimize the hardware performance. Hierarchical memory may be arranged as follows: (1) registers, which provide almost instant access, (2) one or more cache memory 750 layers (e.g., L1, L2, etc.), where each successive cache layer may provide more memory but slower access speed, (3) physical memory (e.g., Random Access Memory (RAM) 752), which provides comparatively slower access speed and (4) storage 754 (e.g., disk), which provides very slow access speed. Examples of memory hierarchy in mobile computing platforms (e.g., smartphones, etc.) are given as follows. The electronic device 722 may include, for example, 16-32 registers, a 16-32 kilobyte (kB) L1 cache, a 256 kB-2 megabyte (MB) L2 cache, RAM 752 and storage 754 (e.g., disk).

Data may be moved into the cache 750 in chunks at a time, where each chunk is a certain size (e.g., cache line). For example, a cache line length may be fixed between 32-64 bytes. Accordingly, some neighboring elements (e.g., a cache line length) may be loaded into the cache memory 750 along with a referenced element. Thus, spatial locality may be a significant factor in data access. Temporal locality is also a factor for elements that will be accessed in the near future. Because of the limited size in the fastest cache (e.g., L1 cache), it may be beneficial to avoid accessing sparse data often. Accessing sparse data reduces both temporal and spatial locality. As discussed above, the approach described in connection with Table 1 required accessing sparse data, thereby reducing both temporal and spatial locality. In comparison, the hybrid data structure 736 significantly improves both temporal and spatial locality because the data being accessed is denser.

In particular, when the electronic device 722 accesses (e.g., requests) a pixel in an image in order to evaluate the pixel (for image segmentation purposes, for example), that pixel as well as a range of other pixels (in row priority order, for example) may be loaded into the cache memory 750 from the RAM 752 and/or storage 754. The processor 748 may traverse the pixels in an order that prioritizes pixels along the same dimension of loading priority (e.g., row priority). For example, because the pixels are loaded into the cache memory 750 in row order (in some configurations), traversing the pixels in an order that prioritizes pixels in the row increases the likelihood of a cache hit (and decreases the likelihood of a cache miss, for instance) when the next pixel is accessed. This improves the functioning of the electronic device 722 (e.g., processor 748, cache memory 750, RAM 752 and/or storage 754) by reducing the frequency and/or probability of accessing data from RAM 752 and/or storage 754. This may allow the electronic device 722 to function more efficiently (e.g., faster and/or with reduced energy consumption). Accordingly, this may save time and/or energy resources (e.g., mobile device battery). This is beneficial in comparison to other approaches where pixel examination is not prioritized similar to cache loading priority.

Some test results involving the systems and methods disclosed herein are given as follows. In particular, two image segmentation application programming interfaces (API) were profiled using the approach described above in connection with Table 1 (denoted “simple data structure”) and the hybrid data structure approach disclosed herein. The image segmentation APIs will be referred to as Image Segmentation A and Image Segmentation B. Image Segmentation A grows an image segment to a meaningful region based on input seeds (e.g., initial pixel). Image Segmentation B grows an image segment to the meaningful region for the whole image. Table 3 illustrates the average time ratio between applying simple data structure and hybrid data structure using a Video Graphics Array (VGA) image (640×480 pixels). It should be noted that “μs” in Table 3 denotes microseconds.

TABLE 3

| | Simple data | Hybrid data | Time |
|---|---|---|---|
| | structure | structure | ratio |
| API | (μs) | (μs) | (speed) |
| Image Segmentation A (gray) | 1878 | 1058 | 1.78 |
| Image Segmentation A (3 | 2729 | 1159 | 2.35 |
| channel color) | | | |
| Image Segmentation B (gray) | 7815 | 4557 | 1.71 |
| Image Segmentation A (3 | 10299 | 5526 | 1.86 |
| channel color) | | | |

The performance ranged from 1.71 to 2.35 times faster when using hybrid data structure compared to the simple data structure.

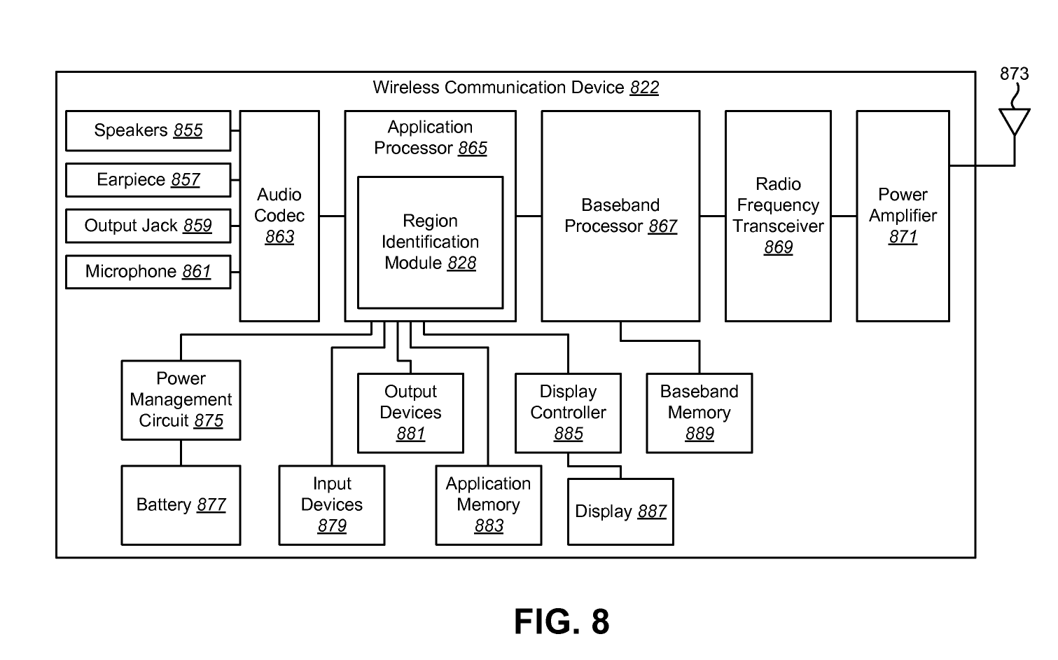

FIG. 8 is a block diagram illustrating one configuration of a wireless communication device 822 in which systems and methods for identifying a region of an image may be implemented. The wireless communication device 822 illustrated in FIG. 8 may be an example of one or more of the electronic devices described herein. The wireless communication device 822 may include an application processor 865. The application processor 865 generally processes instructions (e.g., runs programs) to perform functions on the wireless communication device 822. In some configurations, one or more of the functions (e.g., the transform) disclosed herein may be performed by the application processor 865. For example, the application processor 865 may include and/or implement a region identification module 828. The region identification module 828 may be one example of the region identification module 328 described in connection with FIG. 3. For instance, the application processor 865 may traverse pixels of an image in accordance with a hybrid data structure. The application processor 865 may be coupled to an audio coder/decoder (codec) 863.

The audio codec 863 may be used for coding and/or decoding audio signals. The audio codec 863 may be coupled to at least one speaker 855, an earpiece 857, an output jack 859 and/or at least one microphone 861. The speakers 855 may include one or more electro-acoustic transducers that convert electrical or electronic signals into acoustic signals. For example, the speakers 855 may be used to play music or output a speakerphone conversation, etc. The earpiece 857 may be another speaker or electro-acoustic transducer that can be used to output acoustic signals (e.g., speech signals) to a user. For example, the earpiece 857 may be used such that only a user may reliably hear the acoustic signal. The output jack 859 may be used for coupling other devices to the wireless communication device 822 for outputting audio, such as headphones. The speakers 855, earpiece 857 and/or output jack 859 may generally be used for outputting an audio signal from the audio codec 863. The at least one microphone 861 may be an acousto-electric transducer that converts an acoustic signal (such as a user's voice) into electrical or electronic signals that are provided to the audio codec 863.

The application processor 865 may also be coupled to a power management circuit 875. One example of a power management circuit 875 is a power management integrated circuit (PMIC), which may be used to manage the electrical power consumption of the wireless communication device 822. The power management circuit 875 may be coupled to a battery 877. The battery 877 may generally provide electrical power to the wireless communication device 822. For example, the battery 877 and/or the power management circuit 875 may be coupled to at least one of the elements included in the wireless communication device 822.

The application processor 865 may be coupled to at least one input device 879 for receiving input. Examples of input devices 879 include infrared sensors, image sensors, accelerometers, touch sensors, keypads, etc. For instance, one example of an input device 879 may be the image obtaining module 324 described in connection with FIG. 3. The input devices 879 may allow user interaction with the wireless communication device 822. The application processor 865 may also be coupled to one or more output devices 881. Examples of output devices 881 include printers, projectors, screens, haptic devices, etc. The output devices 881 may allow the wireless communication device 822 to produce output that may be experienced by a user.

The application processor 865 may be coupled to application memory 883. The application memory 883 may be any device that is capable of storing electronic information. Examples of application memory 883 include double data rate synchronous dynamic random access memory (DDRAM), synchronous dynamic random access memory (SDRAM), flash memory, etc. The application memory 883 may provide storage for the application processor 865. For instance, the application memory 883 may store data and/or instructions for the functioning of programs that are run on the application processor 865. In some configurations, the application memory 883 may store image data and/or all or part of a hybrid data structure 336 as described above in connection with FIG. 3. Additionally or alternatively, the application memory 883 may store instructions for identifying a region as described above in connection with FIG. 3.

The application processor 865 may be coupled to a display controller 885, which in turn may be coupled to a display 887. The display controller 885 may be a hardware block that is used to generate images on the display 887. For example, the display controller 885 may translate instructions and/or data from the application processor 865 into images that can be presented on the display 887. Examples of the display 887 include liquid crystal display (LCD) panels, light emitting diode (LED) panels, cathode ray tube (CRT) displays, plasma displays, etc.

The application processor 865 may be coupled to a baseband processor 867. The baseband processor 867 generally processes communication signals. For example, the baseband processor 867 may demodulate and/or decode received signals. Additionally or alternatively, the baseband processor 867 may encode and/or modulate signals in preparation for transmission.

The baseband processor 867 may be coupled to baseband memory 889. The baseband memory 889 may be any electronic device capable of storing electronic information, such as SDRAM, DDRAM, flash memory, etc. The baseband processor 867 may read information (e.g., instructions and/or data) from and/or write information to the baseband memory 889. Additionally or alternatively, the baseband processor 867 may use instructions and/or data stored in the baseband memory 889 to perform communication operations.

The baseband processor 867 may be coupled to a radio frequency (RF) transceiver 869. The RF transceiver 869 may be coupled to a power amplifier 871 and one or more antennas 873. The RF transceiver 869 may transmit and/or receive radio frequency signals. For example, the RF transceiver 869 may transmit an RF signal using a power amplifier 871 and at least one antenna 873. The RF transceiver 869 may also receive RF signals using the one or more antennas 873.

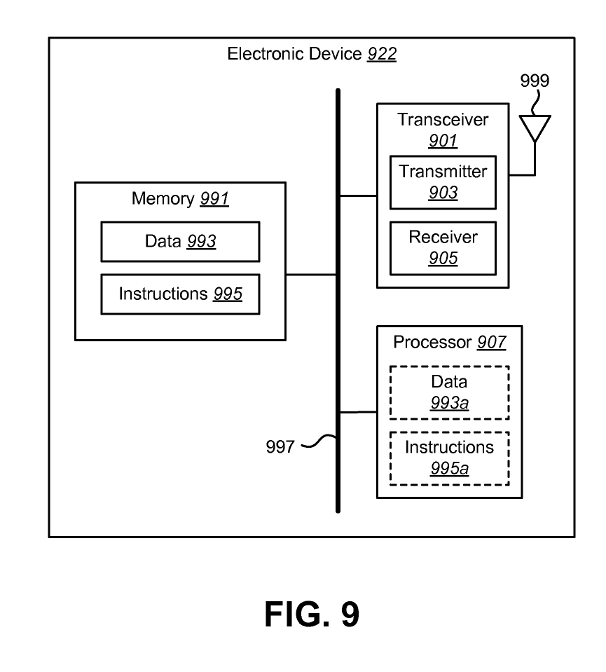

FIG. 9 illustrates certain components that may be included within an electronic device 922. The electronic device 922 described in connection with FIG. 9 may be an example of and/or may be implemented in accordance with one or more of the electronic devices described herein.

The electronic device 922 includes a processor 907. The processor 907 may be a general purpose single- or multi-chip microprocessor (e.g., an ARM), a special purpose microprocessor (e.g., a digital signal processor (DSP)), a microcontroller, a programmable gate array, etc. The processor 907 may be referred to as a central processing unit (CPU). Although just a single processor 907 is shown in the electronic device 922 of FIG. 9, in an alternative configuration, a combination of processors (e.g., an ARM and DSP) could be used.

The electronic device 922 also includes memory 991 in electronic communication with the processor 907 (i.e., the processor 907 can read information from and/or write information to the memory 991). The memory 991 may be any electronic component capable of storing electronic information. The memory 991 may be random access memory (RAM), read-only memory (ROM), magnetic disk storage media, optical storage media, flash memory devices in RAM, on-board memory included with the processor, programmable read-only memory (PROM), erasable programmable read-only memory (EPROM), electrically erasable PROM (EEPROM), registers, and so forth, including combinations thereof.

Data 993 and instructions 995 may be stored in the memory 991. The instructions 995 may include one or more programs, routines, sub-routines, functions, procedures, code, etc. The instructions 995 may include a single computer-readable statement or many computer-readable statements. The instructions 995 may be executable by the processor 907 to implement one or more of the methods described above in connection with one or more of FIGS. 4 and 6. Executing the instructions 995 may involve the use of the data 993 that is stored in the memory 991. FIG. 9 shows some instructions 995a and data 993a being loaded into the processor 907.

The electronic device 922 (e.g., the processor 907 and memory 991) may be implemented in accordance with the electronic device 322 described in connection with FIG. 3. For example, the processor 907 and memory 991 may be configured to perform region identification with a hybrid data structure as described above.

The electronic device 922 may also include a transmitter 903 and a receiver 905 to allow transmission and reception of signals between the electronic device 922 and a remote location (e.g., a base station). The transmitter 903 and receiver 905 may be collectively referred to as a transceiver 901. An antenna 999 may be electrically coupled to the transceiver 901. The electronic device 922 may also include (not shown) multiple transmitters, multiple receivers, multiple transceivers and/or multiple antenna.

The various components of the electronic device 922 may be coupled together by one or more buses, which may include a power bus, a control signal bus, a status signal bus, a data bus, etc. For simplicity, the various buses are illustrated in FIG. 9 as a bus system 997.

In the above description, reference numbers have sometimes been used in connection with various terms. Where a term is used in connection with a reference number, this may be meant to refer to a specific element that is shown in one or more of the Figures. Where a term is used without a reference number, this may be meant to refer generally to the term without limitation to any particular Figure.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

It should be noted that one or more of the features, functions, procedures, components, elements, structures, etc., described in connection with any one of the configurations described herein may be combined with one or more of the functions, procedures, components, elements, structures, etc., described in connection with any of the other configurations described herein, where compatible. In other words, any compatible combination of the functions, procedures, components, elements, etc., described herein may be implemented in accordance with the systems and methods disclosed herein.

The functions described herein may be stored as one or more instructions on a processor-readable or computer-readable medium. The term “computer-readable medium” refers to any available medium that can be accessed by a computer or processor. By way of example, and not limitation, such a medium may comprise Random-Access Memory (RAM), Read-Only Memory (ROM), Electrically Erasable Programmable Read-Only Memory (EEPROM), flash memory, Compact Disc Read-Only Memory (CD-ROM) or other optical disk storage, magnetic disk storage or other magnetic storage devices, or any other medium that can be used to store desired program code in the form of instructions or data structures and that can be accessed by a computer. Disk and disc, as used herein, includes compact disc (CD), laser disc, optical disc, digital versatile disc (DVD), floppy disk and Blu-ray® disc, where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL) or wireless technologies such as infrared, radio, and microwave, then the coaxial cable, fiber optic cable, twisted pair, DSL or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

In the Figures, like reference numbers may indicate functionally similar elements. The systems and methods as generally described and illustrated in the Figures herein could be arranged and designed in a wide variety of different configurations. Thus, the detailed description of several configurations, as represented in the Figures, is not intended to limit scope, as claimed, but is merely representative of the systems and methods.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for identifying a region of an image by an electronic device, comprising:
initializing a hybrid data structure, wherein the hybrid data structure is a combination of stack and queue structures; and
traversing pixels of the image in accordance with the hybrid data structure in an order that prioritizes pixels in a first dimension over pixels in a second dimension, wherein all contiguous pixels of the region in the first dimension are traversed before traversal in the second dimension.

2. The method of claim 1, wherein prioritizing pixels in a first dimension over pixels in a second dimension comprises evaluating neighboring pixels in the first dimension before evaluating neighboring pixels in the second dimension in each iteration.

3. The method of claim 1, wherein prioritizing pixels in a first dimension over pixels in a second dimension provides a greater probability of cache hits.

4. The method of claim 1, further comprising evaluating neighboring pixels of an origin pixel at each iteration to identify any of the neighboring pixels belonging to the region.

5. The method of claim 4, further comprising adding all of the neighboring pixels in the first dimension that belong to the region to the hybrid data structure before adding any of the neighboring pixels in the second dimension that belong to the region.

6. The method of claim 1, wherein the first dimension corresponds to a row dimension of the image and the second dimension corresponds to a column dimension of the image or the first dimension corresponds to a column dimension of the image and the second dimension corresponds to a row dimension of the image.

7. The method of claim 1, wherein the hybrid data structure has a start index, an end index, a reversed start index and a reversed end index.

8. The method of claim 7, further comprising, in an iteration:
decrementing the start index and adding a first pixel in a first direction of the first dimension to the hybrid data structure at the start index in response to determining that the first pixel belongs to the region;
decrementing the start index and adding a second pixel in a second direction of the first dimension to the hybrid data structure at the start index in response to determining that the second pixel belongs to the region;
adding a third pixel in a second direction of the second dimension to the hybrid data structure at the end index and incrementing the end index in response to determining that the third pixel belongs to the region; and
adding a fourth pixel in a first direction of the second dimension to the hybrid data structure at the reversed end index and decrementing the reversed end index in response to determining that the fourth pixel belongs to the region.

9. The method of claim 1, wherein one or more pixels are added to a front of the hybrid data structure and one or more pixels are added from a back of the hybrid data structure.

10. The method of claim 9, wherein traversing pixels of the image comprises traversing the one or more pixels from the back of the hybrid data structure only after no pixel remains for traversal from the front of the hybrid data structure.

11. An electronic device for identifying a region of an image, comprising:
a processor;
memory in electronic communication with the processor; and
instructions stored in the memory, the instructions being executable by the processor to:
initialize a hybrid data structure, wherein the hybrid data structure is a combination of stack and queue structures; and
traverse pixels of the image in accordance with the hybrid data structure in an order that prioritizes pixels in a first dimension over pixels in a second dimension, wherein all contiguous pixels of the region in the first dimension are traversed before traversal in the second dimension.

12. The electronic device of claim 11, wherein prioritizing pixels in a first dimension over pixels in a second dimension comprises evaluating neighboring pixels in the first dimension before evaluating neighboring pixels in the second dimension in each iteration.

13. The electronic device of claim 11, wherein prioritizing pixels in a first dimension over pixels in a second dimension provides a greater probability of cache hits.

14. The electronic device of claim 11, further comprising evaluating neighboring pixels of an origin pixel at each iteration to identify any of the neighboring pixels belonging to the region.

15. The electronic device of claim 14, wherein the instructions are further executable by the processor to add all of the neighboring pixels in the first dimension that belong to the region to the hybrid data structure before adding any of the neighboring pixels in the second dimension that belong to the region.

16. The electronic device of claim 11, wherein the first dimension corresponds to a row dimension of the image and the second dimension corresponds to a column dimension of the image or the first dimension corresponds to a column dimension of the image and the second dimension corresponds to a row dimension of the image.

17. The electronic device of claim 11, wherein the hybrid data structure has a start index, an end index, a reversed start index and a reversed end index.

18. The electronic device of claim 17, wherein the instructions are further executable to, in an iteration:
decrement the start index and add a first pixel in a first direction of the first dimension to the hybrid data structure at the start index in response to determining that the first pixel belongs to the region;
decrement the start index and add a second pixel in a second direction of the first dimension to the hybrid data structure at the start index in response to determining that the second pixel belongs to the region;
add a third pixel in a second direction of the second dimension to the hybrid data structure at the end index and increment the end index in response to determining that the third pixel belongs to the region; and
add a fourth pixel in a first direction of the second dimension to the hybrid data structure at the reversed end index and decrement the reversed end index in response to determining that the fourth pixel belongs to the region.

19. The electronic device of claim 11, wherein one or more pixels are added to a front of the hybrid data structure and one or more pixels are added from a back of the hybrid data structure.

20. A computer-program product for identifying a region of an image, comprising a non-transitory tangible computer-readable medium having instructions thereon, the instructions comprising:
code for causing an electronic device to initialize a hybrid data structure, wherein the hybrid data structure is a combination of stack and queue structures; and
code for causing the electronic device to traverse pixels of the image in accordance with the hybrid data structure in an order that prioritizes pixels in a first dimension over pixels in a second dimension, wherein all contiguous pixels of the region in the first dimension are traversed before traversal in the second dimension.
